(19) United States
(12) Patent Application Publication
(10) Pub. No.: US 2024/0372253 A1
(43) Pub. Date: Nov. 7, 2024

(54) SYSTEMS AND METHODS FOR ELECTRONICALLY STEERABLE ANTENNA INITIAL POSITIONING

(71) Applicant: VIASAT, INC., Carlsbad, CA (US)

(72) Inventors: Aaron J. MENDELSOHN, Carlsbad, CA (US); Mark D. DANKBERG, Carlsbad, CA (US)

(21) Appl. No.: 18/683,761

(22) PCT Filed: Jul. 8, 2022
(86) PCT No.: PCT/US2022/036583

§ 371 Date: Feb. 14, 2024

Related U.S. Application Data
(60) Provisional application No. 63/235,538, filed on Aug. 20, 2021.

(51) Int. Cl. H01Q 3/36; H01Q 1/12

(52) U.S. Cl. CPC H01Q 3/36; H01Q 1/12

(57) ABSTRACT

A satellite communication system having a user terminal with an electronically steerable satellite antenna at an offset angle relative to the zenith direction. Specifically, the offset angle is at least in part based on an inclination of an orbit of at least one non-geosynchronous satellite with which the user terminal is in communication. In addition, the offset angle is in a direction toward the GEO arch. As such, the offset angle may provide improved communication availability to both GEO satellites and non-GEO satellites.

### BACKGROUND

Satellite communication systems have traditionally utilized satellites in geosynchronous Earth orbit (GEO) to facilitate communication between a user terminal on Earth and the GEO satellites. GEO satellites have an orbital period equal to the rotational period of the Earth. As such, GEO satellites may be geostationary or quasi-geostationary such that GEO satellites generally appear stationary or cycle through a very limited range of motion in the sky relative to a user terminal.

However, GEO satellites orbit the Earth at a relatively high altitude of approximately 42,164 km. Because of the distance between the surface of the Earth and GEO satellites, signals communicated between a user terminal on Earth and a GEO satellite are subject to high latency due to the transit time of signals transmitted between the Earth and GEO satellites. Such latency is disadvantageous, especially in certain time sensitive data contexts. In addition, as GEO satellites in geostationary orbits are located above the equator, a limited number of “slots” or spatial availabilities in the geostationary orbit are available. Thus, in order to continue to expand the availability of satellite communication systems, alternative orbital configurations are needed. In view of the foregoing considerations, communication systems may additionally or alternatively use low Earth orbit (LEO) or mid-Earth orbit (MEO) satellites to facilitate communication with user terminals. LEO and MEO satellites and/or orbits may be individually or collectively referred to as non-geosynchronous (non-GEO) herein.

Because non-GEO satellites have orbital periods that are not equal to the rotational period of the Earth, non-GEO satellites do not appear stationary in the sky relative to a user terminal. User terminals for communication with non-GEO satellites typically employ some form of tracking that allows a satellite antenna at the user terminal to target a non-GEO satellite as the non-GEO satellite transits through the sky relative to the user terminal. Such tracking may include movement of the satellite antenna and/or a beam of the satellite antenna. While tracking capabilities add to the complexity of the user station, the ability to use non-GEO satellites for communication with the user terminal provide benefits that counter the additional complexity of the user terminal. However, improvements to non-GEO satellite systems are still desired to improve satellite availability and usage for a given non-GEO satellite constellation.

### SUMMARY

The present disclosure relates to specific techniques for orienting a steerable satellite antenna at a user station to facilitate improved performance of a satellite system. Specifically, the present disclosure contemplates the potential use of a satellite communication system in which one or more GEO satellites may be used in conjunction with one or more non-GEO satellites for communication with a user terminal. In this regard, it has been found that tilting a satellite antenna at a user terminal based on the location of the user terminal on Earth and relative to a GEO satellite may facilitate advantages of satellite availability for both GEO satellites and non-GEO satellites.

Thus, the present disclosure relates to a user terminal of a satellite communication system and related methods. The user terminal includes an electronically steerable satellite antenna having a steerable beam. The steerable beam is electronically steerable through a scan angle relative to a boresight direction of the electronically steerable satellite antenna. The user terminal also includes a physical antenna mount for securing the electronically steerable satellite antenna in a static physical orientation relative to Earth. The static physical orientation of the electronically steerable satellite antenna positions the boresight direction of the electronically steerable satellite antenna at an offset angle relative to a zenith direction at the user terminal. The offset angle is at least in part based on a location of the user terminal on Earth and one or more orbital parameters of a plurality of non-geosynchronous earth orbit (non-GEO) communication satellites of the satellite communication system with which the electronically steerable satellite antenna is configured for communication. Also, the offset angle is in a direction toward at least one geosynchronous earth orbit (GEO) communication satellite.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Other implementations are also described and recited herein.

### BRIEF DESCRIPTIONS OF THE DRAWINGS

FIG. 1 illustrates an example of a satellite communication system.

FIG. 2 illustrates an example of an electronically steerable satellite antenna according to the present disclosure in relation to a local coordinate system.

FIG. 3 illustrates several examples of an electronically steerable satellite antenna with different scan angle capabilities and tilting orientations.

FIG. 4 illustrates an example user terminal in which the steerable satellite antenna is configured with no tilt.

FIG. 5 illustrates an example user terminal in which the steerable satellite antenna is tilted to facilitate improved satellite availability with relatively limited scan angle capability.

FIG. 6 illustrates availability of GEO satellites to an example user terminal oriented without tilt.

FIG. 7 illustrates availability of GEO satellites to an example user terminal oriented with tilt.

FIG. 8 illustrates example user terminals in which respective steerable antennas are tilted to facilitate improved satellite availably and to provide distributed satellite communications to assist with bandwidth distribution to the user terminals.

FIG. 9 illustrates a schematic view of an example user terminal.

FIG. 10 illustrates example operations for a user terminal.

### DETAILED DESCRIPTIONS

While the invention is susceptible to various modifications and alternative forms,

specific embodiments thereof have been shown by way of example in the drawings and are herein described in detail. It should be understood, however, that it is not intended to limit the invention to the particular form disclosed, but rather, the invention is to cover all modifications, equivalents, and alternatives falling within the scope of the invention as defined by the claims.

The present disclosure relates to approaches for improvement of a satellite system that may include at least one non-GEO satellite. Specifically, the present disclosure recognizes the benefits of utilizing an electronically steerable satellite antenna to track one or more non-GEO satellites as the non-GEO satellite transits in the sky relative to the user terminal. For instance, use of an electronically steerable satellite antenna may avoid the use of or reduce the reliance on complex, costly, and failure-prone mechanical tracking mechanisms to physically move a satellite antenna. Rather, the steerable satellite antenna may be installed in a set physical orientation and the electronically steerable satellite antenna may be controlled to directionalize a beam for reception and/or transmission of signals. Electronically steerable satellite antennas may therefore provide a directionalized beam for transmission and/or reception of signals. As such, use of an electronically steerable satellite antenna may allow a user terminal to communicate with non-GEO satellites such that the benefits of such communication (e.g., increased satellite availability, low latency communications, etc.) may be provided to the user terminal.

While reference is made herein to a beam or radiation pattern of an antenna being steerable, such usage is intended to relate generally to the antenna's beam for either directionalizing transmission of signals or directionalizing sensitivity to reception of signals at the antenna through a given scan angle relative to the boresight direction of the antenna. That is, description of a steered or directionalized beam or radiation pattern is not intended to be limited to the transmission of signals from the antenna, but rather may also refer to controlling a direction of the sensitivity of the antenna for reception of signals as well.

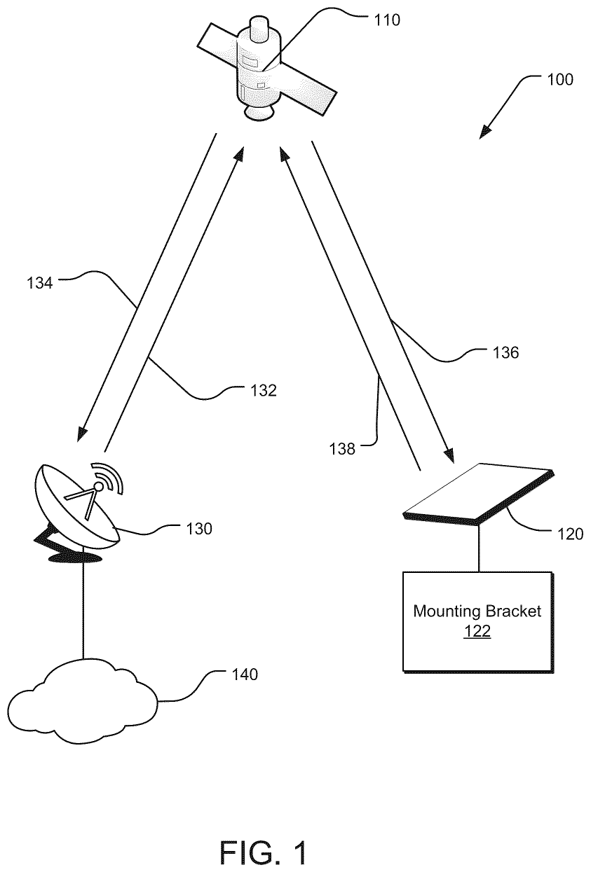

With reference to FIG. 1, an example of a satellite communication system 100 is depicted according to the present disclosure. The system 100 includes a satellite antenna 120 supported by a mounting bracket 122 to dispose the satellite antenna 120 in a set physical orientation relative to Earth. By set physical orientation, it is meant that the mounting bracket 122 is designed to dispose the antenna 120 in a static physical orientation that does change under normal operational conditions to which the antenna may be exposed including, for example, weather events, geological sinking, earthquakes, incidental physical contact with the antenna 120, or the like. As described in greater detail below, the mounting bracket 122 may establish the set physical orientation of the antenna 120 at an azimuth angle, an elevation angle, and a rotation angle. The azimuth angle, the elevation angle, and the rotation angle may be measured with respect to a local coordinate system for the antenna 120 or a global coordinate system. Moreover, it may be appreciated that the orientation of the antenna 120 may be readily translated between a local and global coordinate system as needed.

In an example, the orientation of the antenna 120 is measured with respect to a boresight direction of the antenna 120. For instance, the antenna 120 may comprise an electronically steerable satellite antenna. In this regard, the antenna 120 may comprise a boresight direction along which the gain of the antenna 120 is the greatest. For a planar phased array antenna, the boresight direction may be a vector normal to the planar phased array surface. While the electronically steerable satellite antenna 120 may be operative to steer a beam by controlling a direction of transmission and/or reception sensitivity relative to the boresight direction through a scan angle relative to the boresight direction, the set physical orientation of the antenna 120 may be measured using the boresight direction as a fixed reference datum for the antenna 120.

The antenna 120 may be in bidirectional communication with a satellite 110 in orbit about the Earth. The satellite 110 may also be in bidirectional communication with a gateway terminal 130 on the Earth. The gateway terminal 130 may be in communication with a network 140. The gateway terminal 130 is sometimes referred to as a hub or ground station. The gateway terminal 130 includes an antenna to transmit a forward uplink signal 132 to the satellite 110 and receive a return downlink signal 134 from the satellite 110. The gateway terminal 130 can also schedule traffic to the antenna 120. Alternatively, the scheduling can be performed in other parts of the satellite communications system 100 (e.g. a core node, satellite access node, or other components, not shown). Communication signals 132, 134 communicated between the gateway terminal 130 and the satellite 110 can use the same, overlapping, or different frequencies as communication signals 136, 138 communicated between the satellite 110 and the antenna 120.

The network 140 is interfaced with the gateway terminal 130. The network 140 can be any type of network and can include for example, the Internet, an IP network, an intranet, a wide area network (WAN), a local area network (LAN), a virtual private network (VPN), a virtual LAN (VLAN), a fiber optic network, a cable network, a public switched telephone network (PSTN), a public switched data network (PSDN), a public land mobile network, and/or any other type of network supporting communication between devices as described herein. The network 140 can include both wired and wireless connections as well as optical links. The network 140 can connect multiple gateway terminals 130 that can be in communication with the satellite 110 and/or with other satellites.

The gateway terminal 130 can be provided as an interface between the network 140 and the satellite 110. The gateway terminal 130 can be configured to receive data and information directed to the antenna 120 from a source accessible via the network 140. The gateway terminal 130 can format the data and information and transmit forward uplink signal 132 to the satellite 110 for delivery to the antenna 120. Similarly, the gateway terminal 130 can be configured to receive return downlink signal 134 from the satellite 110 (e.g. containing data and information originating from the antenna 120) that is directed to a destination accessible via the network 140. The gateway terminal 130 can also format the received return downlink signal 134 for transmission on the network 140.

The satellite 110 can receive the forward uplink signal 132 from the gateway terminal 130 and transmit corresponding forward downlink signal 136 to the antenna 120. Similarly, the satellite 110 can receive return uplink signal 138 from the antenna 120 and transmit corresponding return downlink signal 134 to the gateway terminal 130. The satellite 110 can operate in a multiple spot beam mode, transmitting and receiving a number of narrow beams directed to different regions on Earth. Alternatively, the satellite 110 can operate in wide area coverage beam mode, transmitting one or more wide area coverage beams.

The satellite 110 can be configured as a “bent pipe” satellite that performs frequency and polarization conversion of the received signals before retransmission of the signals to their destination. As another example, the satellite 110 can be configured as a regenerative satellite that demodulates and remodulates the received signals before retransmission.

While FIG. 1 depicts a single satellite 110 in communication with the gateway 130 and antenna 120, it may be appreciated that a satellite system 100 may include a plurality of satellites 110. For instance, a plurality of satellites may be simultaneously visible to either a gateway 130 or antenna 120. The satellites 110 of the satellite communication system 100 may include one or more GEO satellites and/or one or more non-GEO satellites (e.g., LEO satellites and/or MEO satellites) without limitation. As will be discussed in greater detail below, tilting of an antenna 120 based on a location of the antenna 120 on the surface of the Earth may facilitate a number of advantages in relation to satellite availability and/or usage.

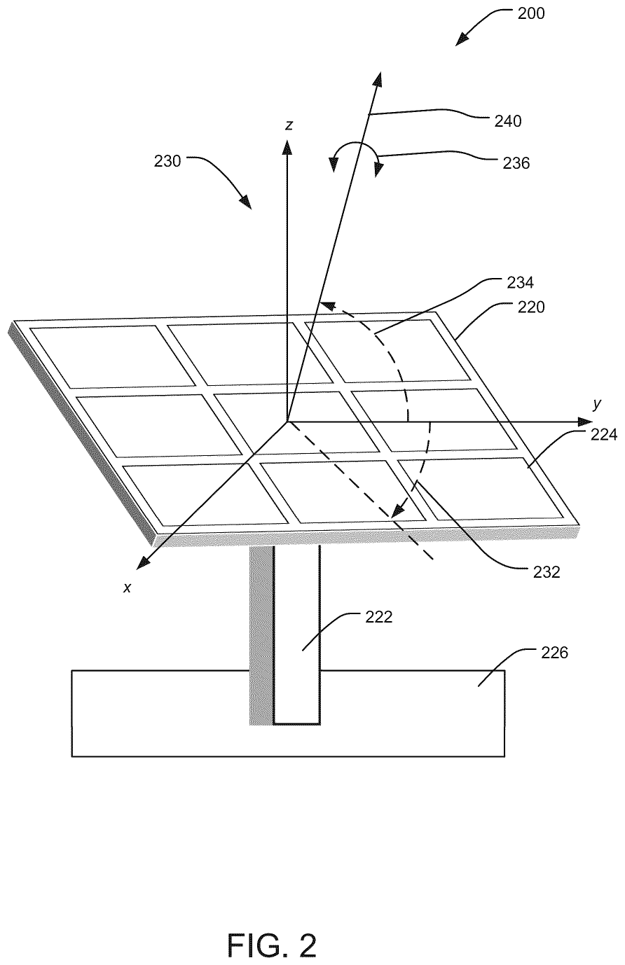

With further reference to FIG. 2, an example of an antenna 200 is shown in greater detail. The antenna 200 may comprise an electronically steerable satellite antenna such as phased array antenna or the like. In other examples, other electronically steerable satellite antennas other than phased array antennas may be provided without limitation. For instance, the electronically steerable satellite antenna may comprise an antenna having a liquid crystal polymer based aperture, an antenna having a counter rotating aperture coupled slotted plates, an antenna utilizing barium strontium titanite or other similar voltage dependent dielectric material, or a metamaterial based antenna. In one example, the antenna 200 may include a plurality of antenna elements 224. The plurality of antenna elements 224 may comprise an antenna array and beamforming circuitry (e.g., phase shifters, amplifiers, etc.) that may be controlled collectively to provide a steerable beam. The steerable beam may allow for directionalized reception of signals and/or directionalized transmission of signals in the direction of the steered beam without limitation.

While a rectangular array of rectangular antenna elements 224 is depicted in FIG. 2, it may be appreciated that any configuration, shape, and/or array of antenna elements 224 may be provided without limitation (e.g., including antenna elements 224 of a different shape such as triangular, hexagonal, octagonal, or other polygon shape in any appropriate array layout without limitation). In turn, various types of beams may be generated by the satellite antenna 120 with varying spread and/or power characteristics. Therefore, while discussion herein may refer to or depict a conical fields through which the beam may be controlled, the present disclosure is not limited to such examples. For instance, the scan angle may be asymmetrical about the boresight direction to provide a rectangular or other polygonal shaped field through which the beam may be controlled.

The antenna 220 may be supported by a mounting bracket 222. In turn, the mounting bracket 222 may be secured to a base 226. The base 226 may be a permanent or static structure relative to the Earth. For instance, the base 226 may comprise an installation pad, a building, or any other static structure. The mounting bracket 222 may provide one or more degrees of freedom for the antenna 220 to set the physical orientation of the antenna 220. In one example, the mounting bracket 222 may provide at least three degrees of freedom in which the azimuth angle, elevation angle, and rotation angle of the antenna 220 may be adjusted. Regardless of the adjustability of the mounting bracket 222, the mounting bracket 222 may be secured to position the antenna 220 in a set physical orientation. As described above, the set physical orientation may be static such that operational conditions to which the antenna 220 is exposed may not move the antenna 220.

FIG. 2 illustrates an example coordinate system 230 in which the set psychical orientation of the antenna 220 may be described. The coordinate system 230 may include an x-axis, a y-axis, and a z-axis defining a local three dimensional coordinate system relative to the antenna 220. A boresight direction 240 of the antenna 220 may be positioned in the coordinate system 230. As described above, a boresight direction 240 of the antenna 220 describes an axis of maximum gain for the antenna 220. In the case of an electronically steerable satellite antenna, while the beam may be steerable without physical movement of the antenna 220 through a scan angle relative to the boresight direction 240

The boresight direction 240 may be described in the coordinate system 230 by an azimuth angle 234, an elevation angle 232, and a rotation angle 236 as shown in FIG. 2. As the coordinate system 230 may be static in a reference frame relative to the Earth, the azimuth angle 234, the elevation angle 232, and the rotation angle 236 may fully describe the set physical orientation of the antenna 220 relative to the Earth. That is, the azimuth angle 234, the elevation angle 232, and the rotation angle 236 may be translated between a local coordinate system (e.g., coordinate system 230) and a global coordinate system relative to the Earth.

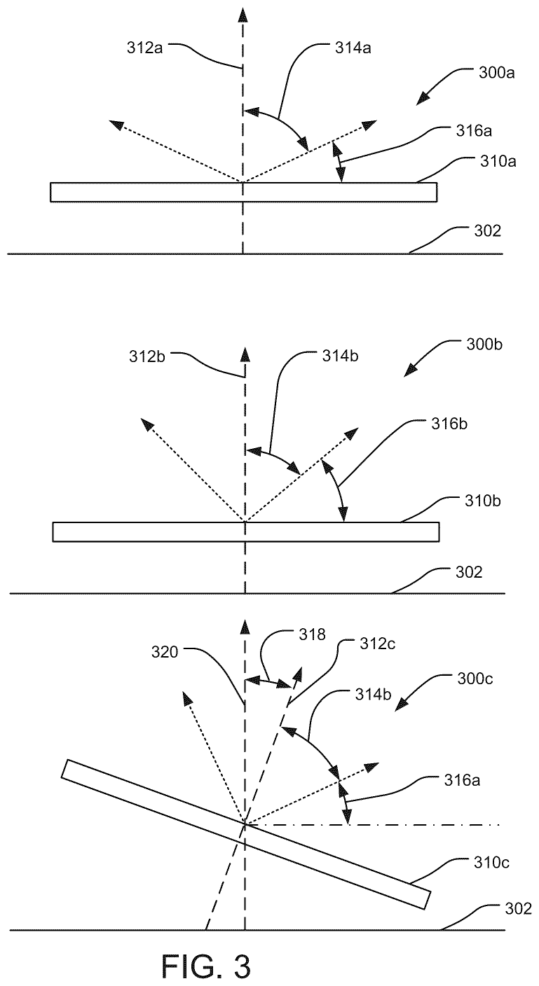

FIG. 3 illustrates three examples of an electronically steerable satellite antenna denoted as 300a, 300b, and 300c. The first example 300a includes an electronically steerable satellite antenna 310a in which a boresight direction 312a is oriented perpendicular to a local horizontal datum 302. That is, the boresight direction 312a points in the direction of a zenith of the location at which the antenna 310a is located. Thus, the satellite antenna 310a can be characterized as in a zenith-oriented configuration. The horizontal datum 302 may comprise a plane tangential with the surface of the Earth at the location of the antenna 310a.

The antenna 310a comprises a scan angle 314a through which a beam of the antenna 310 may be controlled. In this example 300a, the scan angle 314a comprises a 65 degree angle relative to the boresight direction 312a. As can be appreciated, this provides a total beam sweep angle of 135 degrees. Accordingly, a minimum elevation angle 316a of 35 degrees is established for the antenna 310a relative to the horizontal datum 302.

The example 300a may be considered a baseline example that establishes a minimum elevation angle 316a used for comparison of the performance of the configurations of the antennas 310 illustrated in FIG. 3. In other examples, other minimum elevation angles may be provided without limitation such as a minimum elevation angle of about 5 degrees, about 10 degrees, about 15 degrees, about 20 degrees, about 30 degrees, or even about 35 degrees or greater.

Turning to example 300b, an electronically steerable satellite antenna 310b is provided. Like the example 300a, in example 300b, the antenna 310b is oriented such that a boresight direction 312b is oriented perpendicular to a local horizontal datum 302. That is, the boresight direction 312b points in the direction of a zenith of the location at which the antenna 310b is located. Thus, the satellite antenna 310b can be characterized as in a zenith-oriented configuration.

However, unlike example 300a, the antenna 310b of example 300b may have a more limited scan angle 314b. A scan angle 314b of an antenna 310 may be limited for any number of reasons. However, one important factor is the economic feasibility of the antenna 310. For electronically steerable antennas like those shown in the examples of FIG. 3, the cost to produce an antenna grows exponentially with available scan angle 314. That is, a first antenna with twice the scan angle of a second antenna typically costs more than twice the second antenna. Thus, it is desirable, and potentially required to achieve economic feasibility, to provide antennas 310 with limited scan angles 314. For instance, the antenna 310b comprises a scan angle 314b of 45 degrees, which may provide significant financial advantage over the antenna 310a. However, in other examples, satellite antennas may have other available scan angles including, for example, scan angles of about 15 degrees, about 20 degrees, about 25 degrees, about 30 degrees, about 35 degrees, about 40 degrees, about 45 degrees, about 50 degrees, about 55 degrees, about 60 degrees, or greater than about 60 degrees. However, as the scan angle 314b in example 300b is more limited than the scan angle 314a, a resulting minimum elevation angle 316b in example 300b is greater than the minimum elevation angle 316b in example 300a. Thus, the antenna 310b would have more limited capability to communicate with satellites as satellites transit toward the local horizon at the antenna 310b. In turn, a satellite communication system that includes antennas 310b as configured in example 300b may require more satellites to be in orbit in a satellite constellation to maintain continuous communication with antennas 310b oriented as shown and described in example 300b. As can be appreciated, the use of additional satellites in a constellation may add significantly to the cost and complexity of the satellite system.

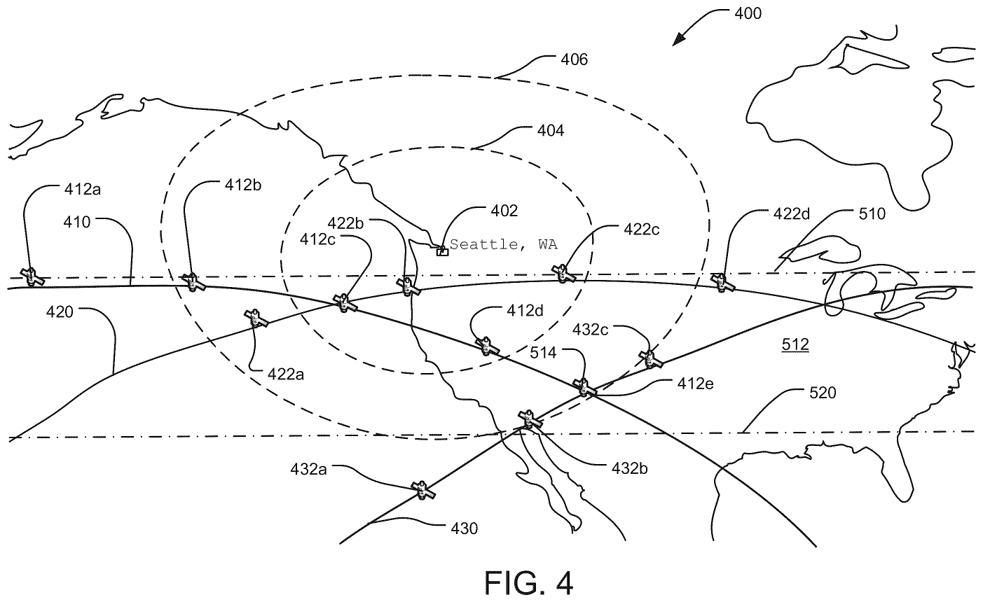

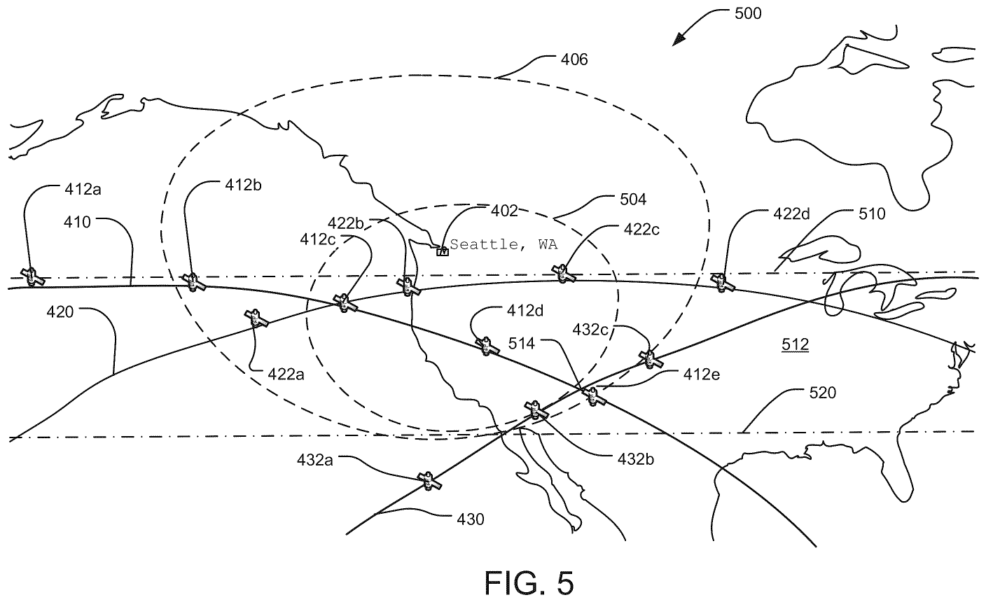

However, with further reference to example 300c of FIG. 3, an electronically steerable satellite antenna 310c with a more limited scan angle 314b may be tilted relative to the zenith direction 320. For example, the antenna 310c may be tilted such that the boresight direction 312c of the satellite antenna 310c is at an offset angle 318 relative to the zenith direction 320. In the depicted example, the offset angle 318 may be 20 degrees relative to the zenith direction 320. As such, the boresight direction 312c of the antenna 310c may be offset from the zenith direction of the location of the antenna 310c. In turn, even with the more limited scan angle 314b as compared to the scan angle 314a, the minimum elevation angle 316a achieved in example 300a may also be achieved in example 300c with the more cost effective antenna 310c with a more limited scan angle 314b. While the improved minimum elevation angle 316a may be achieved through a limited azimuth angle extent for the antenna 310a, the discussion of FIGS. 4 and 5 illustrate how configuring an antenna tilt angle based at least in part on a location of the antenna on Earth may mitigate any limitations in the minimum elevation angle over the full extent of azimuth angle relative to the antenna.

Turning to FIG. 4, an example 400 is presented of a map to illustrate limitations on steerable antennas with relatively limited scan angles when the steerable antenna is configured in a zenith-oriented configuration according to examples 300a and 300b of FIG. 3.

The representation 400 illustrates varying extents of visibility 404/406 corresponding to respective examples of electronically steerable satellite antennas at a given location 402 in a zenith-oriented configuration in which the boresight direction of the satellite antennas are pointed directly at the zenith relative to the location 402. In the depicted representation 400, the satellite antennas are located in Seattle, WA in the continental United States. The first extent of visibility 406 represents a projection of the visible extent of a satellite antenna with a first scan angle (e.g., a 65 degree scan angle as illustrated in example 300a of FIG. 3). That is, a satellite on a ground track within the first extent of visibility 404 would be visible to the satellite antenna having the first scan angle at the location 402. In contrast, the second extent of visibility 404 represents a projection of the visible extent of a satellite antenna with a second scan angle that is smaller than the first scan angle (e.g., a 45 degree scan angle as illustrated in example 300b of FIG. 3). That is, a satellite on a ground track within the second extent of visibility 406 would be visible to the satellite antenna having the second scan angle at the location 402. As can be appreciated, as each example satellite antenna is configured to be provided in a zenith-oriented configuration, the first extent of visibility 406 and the second extent of visibility 404 comprise concentrically arranged shapes with the second extent of visibility 404 being smaller than the first extent of visibility 406.

FIG. 4 also illustrated portions of satellite orbit ground tracks. Specifically, a first ground track 410, a second ground track 420, and a third ground track 430 are illustrated. As may be appreciated, the representation of the first ground track 410, the second ground track 420, and the third ground track 430 are truncated to illustrate only portions of the se ground tracks relevant to the extents of visibly 404/406 in FIG. 4. The first ground track 410 includes satellites 412a, 412b, 412c, 412d, and 412e. As may be appreciated, the first ground track 410 may correspond to a first orbit in which the satellites 412a, 412b, 412c, 412d, and 412e orbit the Earth. The satellites 412a, 412b, 412c, 412d, and 412e may have common orbital parameters, but be offset relative to satellite epoch such that the plurality of satellites are spaced (e.g., spaced evenly) along a common ground path. The second ground track 420 includes satellites 422a, 422b, 422c, and 422d. As may be appreciated, the second ground track 420 may correspond to a second orbit in which the satellites 422a, 422b, 422c, and 422d orbit the Earth. The satellites 422a, 422b, 422c, and 422d may have common orbital parameters, but be offset relative to satellite epoch such that the plurality of satellites are spaced (e.g., spaced evenly) along a common ground path. The third ground track 430 includes satellites 432a, 432b, and 432c. As may be appreciated, the third ground track 430 may correspond to a third orbit in which the satellites 432a, 432b, and 432c orbit the Earth. The satellites 432a, 432b, and 432c may have common orbital parameters, but be offset relative to satellite epoch such that the plurality of satellites are spaced (e.g., spaced evenly) along a common ground path.

As can be appreciated, for the first extent of visibility 406, the visible satellites that are visible at the time depicted in FIG. 4 include satellites 412b, 412c, 412d, and 412e in the first ground track 410; satellites 422a, 422b, and 422c in the second ground track 420; and satellite 432b in the third ground track. In contrast, for the second extent of visibility 404, the visible satellites that are visible at the time depicted in FIG. 4 include satellites 412c and 412d in the first ground track; satellites 422b and 422c in the second ground track 420; and no satellites in the third ground track 430. Thus, it may be appreciated that while the limited extent of visibility provided by the second extent of visibility 404 may provide a more economic satellite antenna, the number of available satellites is significantly decreased relative to the first extent of visibility 406. In turn, it may be that satellite availability is decreased, thus jeopardizing the ability to provide constant visibility to at least one satellite in the satellite constellation. In turn, it may be that more satellites are needed in the constellation to ensure the ability to provide constant visibility to at least one satellite in the constellation, which may offset any economic advantage provided by the more limited scan angle of the satellite antenna, even if aggregated over many satellite antennas having a smaller scan angle.

In contrast, FIG. 5 illustrates a representation 500 of the same satellite orbital configuration depicted in FIG. 4. FIG. 5 also illustrates the first extent of visibility 406 associated with a satellite antenna in a zenith-oriented configuration with a first scan angle. A tilted extent of visibility 504 is also depicted that illustrates a satellite antenna generally provided according to the example 300c in FIG. 3 in which a satellite antenna with a more limited scan angle may be tilted at an offset angle such that the boresight direction of the satellite antenna is offset relative to the zenith direction at the location 402 of the satellite antenna. In turn, in FIG. 5, the offset angle for the satellite antenna with the tilted extent of visibility 504 may generally be to the south such that the tilted extent of visibility 504 generally extends farther to the south than it does to the north relative to the location 402. In turn, the number of visible satellites available in the tilted extent of visibility 504 includes satellite 412c and 412d in the first ground track 410; satellites 422b and 422c in the second ground track; and satellite 432b in the third ground track 430. That is, the number of available satellites visible in the tilted extent of visibility 504 is greater than the second extent of visibility 404 in FIG. 4 even though the tilted extent of visibility 504 is produced with a satellite antenna with the same scan angle capability of the antenna represented by the second extent of visibility 404.

The increase in available satellites in view of the tilted extent of visibility 504 is at least in part due to the pooling of satellites near the angle of inclination of the orbit of a satellites such that more satellites are generally available near the angle of inclination. For example, an upper bound of inclination 510 and a lower bound of inclination 520 are depicted in FIGS. 4 and 5. Thus, an area between the upper bound of inclination 510 and the lower bound of inclination 520 may be referred to as a pooling region 512. By pooling, it is meant that satellites may linger in the pooling region 512 extending between the upper bound of inclination 510 and the lower bound of inclination 520 as the satellites transit through the portion of the orbit near the inclination of the orbit. The upper bound of inclination 510 may be defined by the angle of inclination of the orbits of the non-GEO satellite constellation. The upper bound of inclination 510 may correspond to the angle of inclination or be some margin greater than the angle of inclination. The lower bound of inclination 520 may be defined relative to the overlapping ground tracks of an ascending satellite orbit and as descending satellite orbit (e.g., intersection 514 between a descending portion of ground track 410 and an ascending portion of ground track 430). The lower bound of inclination 520 may pass through the intersection 514 or be provided at some margin below the intersection 514.

In any regard, a satellite antenna may be oriented at an offset angle such that the tilted extent of visibility 504 may generally extent to the pooling region 512 between the upper bound of inclination 510 and the lower bound of inclination 520. In contrast, as shown in FIG. 4, the second extent of visibility 404 includes a large area of visibility through which no satellite will transit as it extends to latitudes through which no satellites pass beyond the upper bound of inclination 510. Thus, the portion of the extent of visibility 404 outside of the upper bound of inclination 510 is wasted as no satellites will pass through this portion.

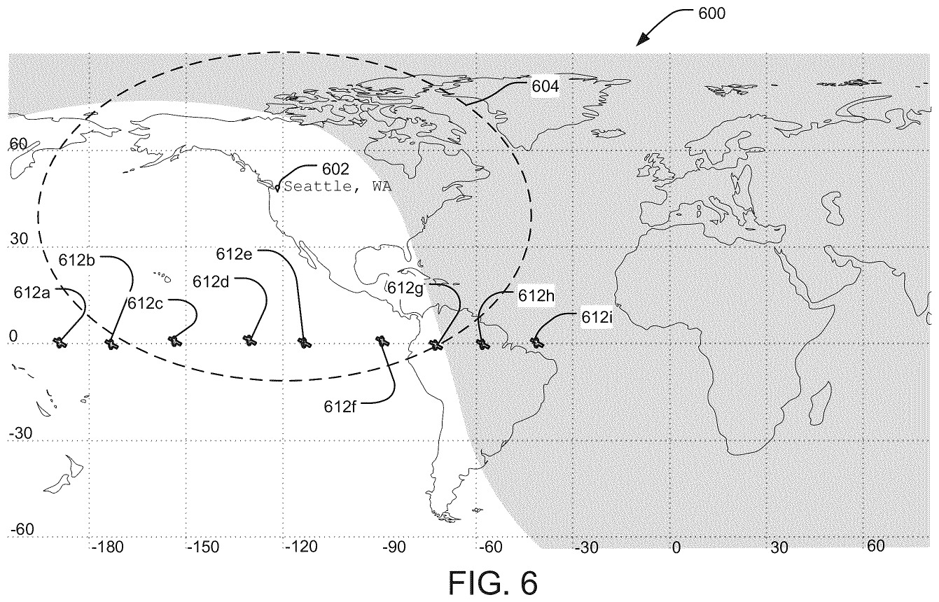

The tilting of a satellite antenna to provide a tilted extent of visibility targeting a portion of orbits near the inclination angle of the orbits in which satellites pool in the pooling region 512 may also provide benefits in the event the satellite antenna also communicates with GEO satellites. For instance, FIG. 6 illustrates a representation 600 of an extent of visibility 604 for a satellite antenna at a location 602 with a given scan angle. The extent of visibility 604 illustrates a satellite antenna in a zenith-oriented configuration in which the boresight direction of the satellite antenna is directed toward the zenith.

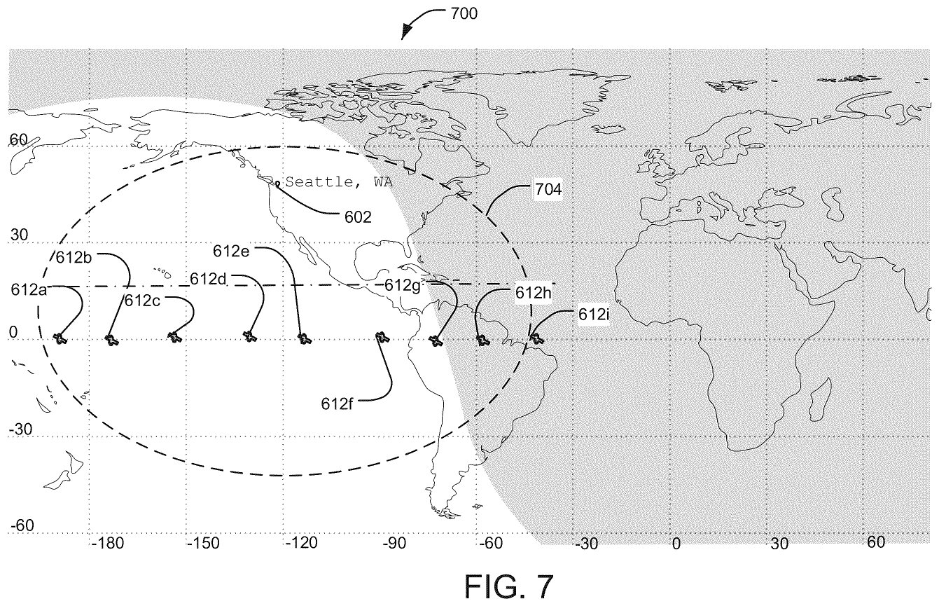

In FIG. 6, a number of GEO satellites 612a-612i are depicted. As can be appreciated, the extent of visibility 604 for the zenith-oriented satellite antenna is limited to GEO satellites 612c-612g. In contrast, FIG. 7 illustrates another representation 700 of a satellite antenna at the same location 602 and having the same given scan angle, but in which the satellite antenna is provided at an offset angle in a direction toward a GEO arch in which GEO satellites are provided. As such, a tilted extent of visibly 704 is provided that is tilted toward the GEO arch in which the GEO satellites orbit. The area of the tilted extent of visibility 704 is the same as the extent of visibly 604, but because the satellite antenna is tilted toward the GEO arch, more GEO satellites comprising GEO satellites 612a-612h may be visible within the tilted extent of visibility 704.

The tilted extent of visibility 504 illustrated in FIG. 5 relative to non-GEO satellite orbits represented by the first ground track 410, second ground track 420, and the third ground track 430 may also facilitate the tilted extent of visibility 704 illustrated in FIG. 7 relative to GEO satellites. Thus, as can be appreciated, by providing a satellite antenna's boresight direction at an offset angle toward the GEO arch, the availability of visibility to non-GEO satellites and GEO satellites may both be increased.

In this regard, a given satellite antenna tilted at an offset angle 318 in a manner shown in example 300c in FIG. 3, in which the offset angle 318 of the satellite antenna is toward the GEO arch (e.g., toward the direction of the equator relative to the location of the satellite antenna) may be able to target either a non-GEO satellite constellation and/or one or more GEO satellites for communication therewith. This may provide increased flexibility with respect to the communication capability of a given user terminal having a satellite antenna at an offset angle. Data may be selectively communicated with a given one of a non-GEO satellite visible to the user terminal or a GEO satellite visible to the user terminal. For example, communication of latency sensitive data such as voice communications, live video streams, or the like may be selectively targeted to a non-GEO satellite visible to the user terminal to provide relatively lower latency communication. In contrast, other data that is not sensitive to latency may be targeted to a GEO satellite visible to the user terminal. This may facilitate increased bandwidth, continual satellite availability, or other benefits of GEO satellite communication. As the tilting of a satellite antenna toward the GEO arch may facilitate increased satellite visibility for both satellites in GEO orbits and satellites in non-GEO orbits, this flexibility is further enhanced by potentially allowing fewer non-GEO satellites and/or GEO satellites to be maintained while still providing the ability to provide constant visibility to a user terminal.

Thus, as may be appreciated, the direction and/or amount of the offset angle of the satellite antenna's boresight direction relative to the local zenith at a satellite antenna's location may be based on a location of the satellite antenna on Earth (e.g., the satellite location's latitude). More specifically, the tilt of the satellite antenna may be based on the location of a satellite antenna relative to an angle of inclination of a non-GEO constellation of satellites with which the satellite antenna communicates. In addition, as demonstrated above, it may be advantageous to provide tilt toward the GEO arch. In this regard, it may be that a non-GEO satellite constellation may be designed to have an angle of inclination that allows satellite antennas in a targeted geographic region (e.g., the continental United States, continental Europe, the Eastern Asian seaboard, etc.) to tilt toward the GEO arch while also providing good coverage to a pooling region defined relative to the non-GEO satellite orbits. That is, the angle of inclination of the non-GEO satellite orbit may be determined relative to the extents of latitude of the targeted geographic region such that for some, most, or all locations within the geographic area of interest, a tilt toward the GEO arch also increases an extent of visibility coverage in pooling region for the non-GEO orbits.

In still other examples, the tilting angle of a given satellite antenna may be at least in part based on anticipated usage. For example, a first satellite antenna at a given location that is anticipated to primarily be used in communication of data that is not latency sensitive such that the satellite antenna primarily communicates with a GEO satellite may be tilted a greater degree toward the GEO arch than compared to a second satellite antenna at the given location that is anticipated to communicate more latency sensitive data than the first satellite. That is, the physical tilt of the satellite antenna may be based, at least in part, on the anticipate nature of the data communication and/or the anticipated balance of communication between a GEO satellite and a non-GEO satellite.

The offset angle may additionally or alternatively be at be at least in part based on link performances of the respective links relative to non-GEO satellites and GEO satellites. For example, a first link condition relative to a non-GEO satellite may be determined, and a second link condition relative to a GEO satellite may be determined. The offset angle of the satellite antenna may be at least in part based on the first link condition and the second link condition. For instance, an offset angle may be provided to favor the satellite antenna toward a satellite link having worse link conditions than another link in an attempt to improve link conditions. In alternative examples, an offset angle may be provided toward a satellite link having better link conditions to more efficiently avail the satellite antenna of the improved link conditions.

Further still, while the tilting described above generally contemplates tilting of a satellite antenna to have an offset angle only with a longitudinal offset component, providing an offset angle with a latitudinal offset component may also provide advantages. By a longitudinal offset component, it is meant that the offset angle of the satellite antenna is provided in the longitudinal direction (e.g., to the north or to the south) relative to the location of the antenna). Correspondingly, a latitudinal offset component means that the offset angle of the satellite antenna is provided in the latitudinal direction (e.g., to the east or to the west) relative to the location of the antenna). Specifically, one example of use of a latitudinal offset component may be based on a load balancing policy as described below.

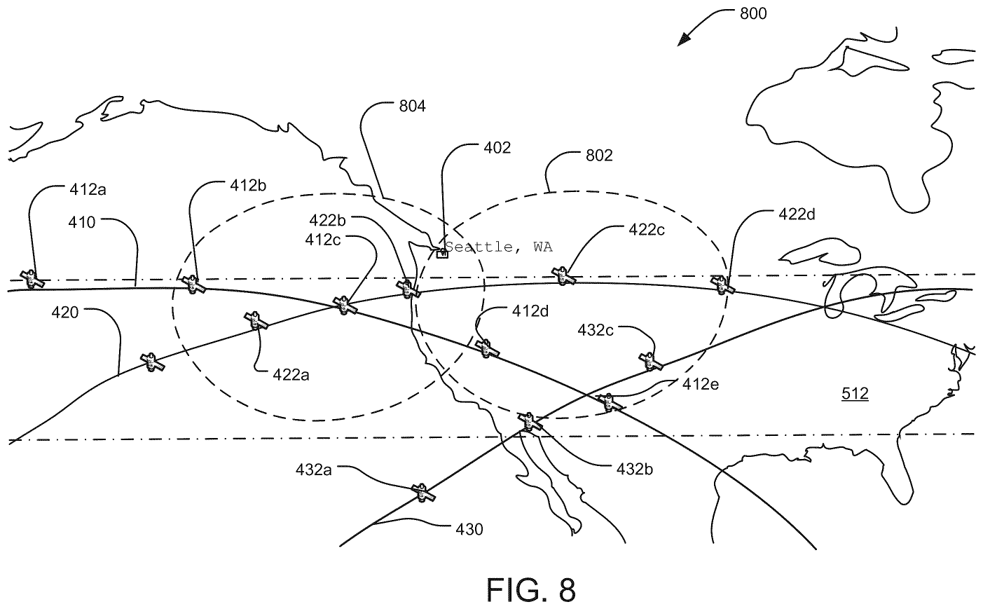

One such example of providing a latitudinal offset component according to a load balancing policy is illustrated in FIG. 8. In FIG. 8, depicts a representation 800 of a location 402 at which two satellite antennas are located. The non-GEO satellite constellation is arranged as provided above in relation to FIGS. 4 and 5 generally including a first ground track 410, a second ground track 420, and a third ground track 430 along which respective satellites are transiting.

FIG. 8 depicts a first extent of visibility 802 associated with a first satellite antenna and a second extent of visibility 804 associated with a second satellite antenna. The first extent of visibility 802 extends to the south east relative to the location 402. In this regard, the offset angle of the boresight direction of the first satellite antenna may have a longitudinal offset component to orient the boresight direction toward the GEO arch and to target the pooling region 512 of the satellite constellation. In addition, the offset angle of the boresight direction of the first satellite antenna may have a latitudinal component to generally offset the extent of visibility 802 to the east relative to the location 402. The second extent of visibility 804 extends to the south west relative to the location 402. In this regard, the offset angle of the boresight direction of the second satellite antenna may have a longitudinal offset component to orient the boresight direction toward the GEO arch and to target the pooling region 512 of the satellite constellation like the first satellite antenna.

In the depicted example, the longitudinal offset component of the offset angle for the first extent of visibility 802 and the second extent of visibly 804 may be the same. That is, the first satellite antenna and the second satellite antenna may have the same amount of offset angle in the southern direction relative to the location 402. In addition, the offset angle of the boresight direction of the second satellite antenna may have a latitudinal component to generally offset the extent of visibility 804 to the west relative to the location 402.

The divergent latitudinal offset components may allow for different sets of satellites to be targeted by the first satellite antenna and the second satellite antenna, respectfully. For example, the first extent of visibility 804 may allow the first satellite antenna to view satellite 412d and satellite 412e in the first ground track 410; satellite 422c and satellite 422d in the second ground track; and satellite 432c in the third ground track 430. The second extent of visibility 804 may allow the second satellite antenna to view satellite 412b and satellite 412c in the first ground track 410; satellite 422a and 422b in the second ground track 420; and no satellite in the third ground track 430.

As the set of satellites visible to the first satellite antenna and the second satellite antenna may be different, it may be appreciated that the latitudinal component may be used to assist in load balancing of communication with the satellites in the non-GEO satellite constellation. That is, by varying the latitudinal offset component for satellite antennas at a given location or within a specified region, different ones of the satellites in the constellation may be targeted, thus providing a greater variety of satellites with which communication may be established. In turn, rather than having bandwidth from both of the satellite antennas being shared by the same satellites, each satellite antenna may have a different set of satellites available, thus increasing the total available bandwidth available to the two satellite antennas. In some examples, the set of satellites visible by the first satellite antenna and the second satellite antenna, respectively, may include common satellites. However, each set of satellites may also include unique satellites relative to the other set.

The latitudinal offset component for a given satellite antenna may be determined based on a load balancing policy. The latitudinal offset component may be determined in relation to other user terminals in a given location or region of the satellite antenna. For example, every other satellite antenna install may be assigned a given latitudinal offset components. Thus, a first satellite antenna installed may be offset to the east, a second satellite antenna installed may be offset to the west, a third satellite antenna installed may be offset to the east, and so forth. Alternatively, latitudinal offset components may be randomly assigned.

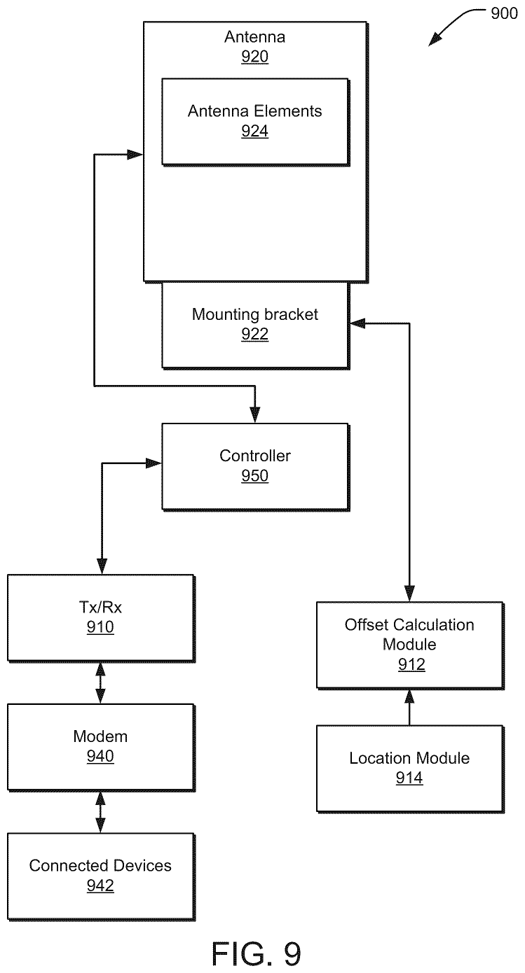

FIG. 9 presents a schematic representation of an example antenna system 900. An antenna 920 is schematically illustrated with antenna elements 924 and as being supported by a mounting bracket 922. In this regard, the antenna 920 may correspond to the forgoing description of the antenna 220 described above.

The antenna 920 may be in communication with an antenna controller 950. The antenna controller 950 may be in operative communication with a transceiver 910. The transceiver 910 may coordinate with the antenna controller 950, which may include control circuitry or other means for controlling the operation of the antenna 920 to facilitate communication with a satellite (not shown in FIG. 3). For example, the transceiver 910 may direct the antenna controller 950 to control the antenna elements 924 to steer a beam of the antenna 920 through scan angles with respect to azimuth angles and elevation angles relative to the antenna 920. Such control of the antenna elements 924 may allow the beam of the antenna to be directed through the range of scan angles relative to the boresight direction of the antenna.

The transceiver 910 may amplify and then downconvert a forward downlink signal (as shown in FIG. 1) from a target satellite to generate an intermediate frequency (IF) receive signal for delivery to a modem 940. Similarly, the transceiver 910 may upconvert and then amplify an IF transmit signal received from modem 940 to generate the return uplink signal (as shown in FIG. 1) for delivery to a target satellite. In some embodiments in which a target satellite operates in a multiple spot beam mode, the frequency ranges and/or the polarizations of the return uplink signal and the forward downlink signal may be different for the various spot beams. Thus, the transceiver 910 may be within the coverage area of one or more spot beams, and may be configurable to match the polarization and the frequency range of a particular spot beam. The modem 940 may for example be located inside the structure to which the antenna 920 is attached. As another example, the modem 940 may be located on the antenna 920, such as being incorporated within the transceiver 910. In any regard, the transceiver 910 may receive and send signals via the antenna 920 to provide communication capability of the modem 940 (e.g., to facilitate access between the modem 940 and a network). That is, the modem 940 respectively modulates and demodulates the IF receive and transmit signals to communicate data with a router (not shown). The router may for example route the data among one or more connected devices 942, such as laptop computers, tablets, mobile phones, etc., to provide bidirectional data communications, such as two-way Internet and/or telephone service.

The system 900 may also include or be in communication with a location module 914. The location module 914 may be operative to determine the location of the antenna 920 (e.g., as described by latitude, longitude, and elevation). In turn, the location module 914 may provide the location of the antenna 920 to an offset calculation module 912 for use in determining the offset angle of the antenna 920 according to any of the foregoing considerations related to the offset angle. In turn, the offset calculation module 912 may provide an output that allows the mounting bracket 922 of the satellite antenna 920 to be manipulated to the offset angle as determined by the offset calculation module 912. Such manipulation may occur manually by a user or may control a positioning system of the mounting bracket 922 automatically.

The location module 914 may, for example, comprise a Global Positioning System (GPS) receiver capable of resolving a location of the antenna 920 on Earth (e.g., relative to a universal coordinate system such as using latitude, longitude, and elevation). Any other appropriate location determining technology may be used by the location module 914 without limitation.

In some examples, one or more of the antenna controller 950, transceiver 910, modem 940, offset calculation module 912, and/or location module 914 may be integrally provided with the antenna 820 despite being shown as separate modules in FIG. 9 for clarity. Further still, some of the modules recited above may be located remotely from the antenna 920 and/or user terminal associated with the antenna such that he functionality of the module may be facilitated through networked communication (e.g., including communication using communication with a satellite).

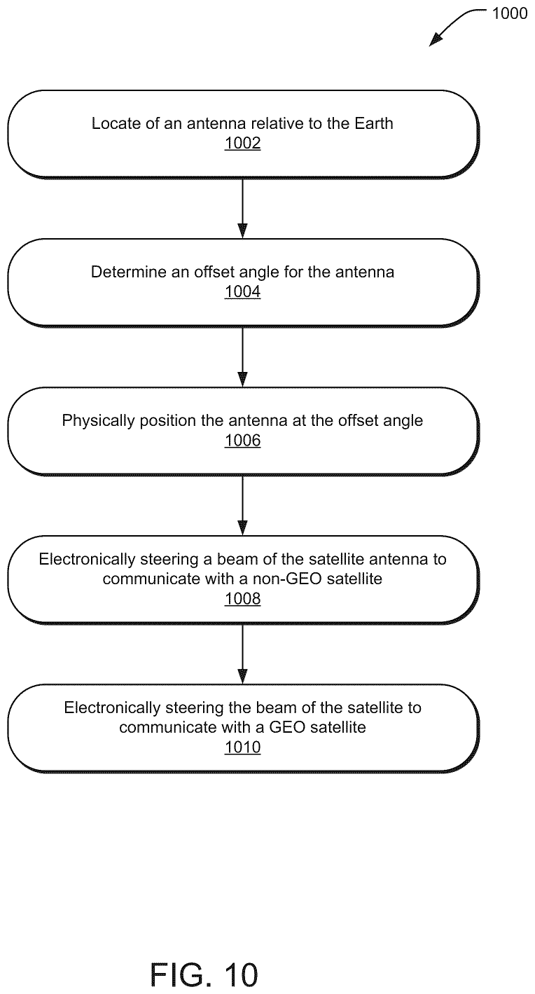

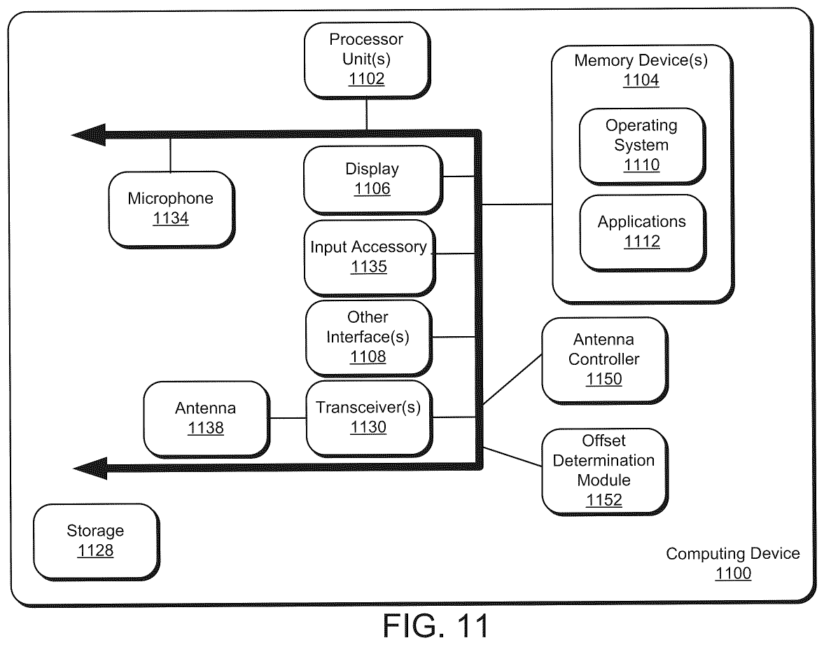

FIG. 10 illustrates example operations 1000 for a satellite system. The operations 1000 may include a locating operation 1002 in which a location of a satellite antenna is determined relative to Earth. The locating operation 1002 may be performed by a location module such as a GPS module or the like as discussed above. Alternatively, the location of the satellite antenna may be determined in any other manner such as obtaining coordinates for the antenna, obtaining an address of the antenna, locating the antenna with a location module external to the antenna system, etc.

In any regard, a determining operation 1004 is used to determine an offset angle for the satellite. The determining operation 1004 may at least be in part based on the location of the antenna determined at the locating operation 1002. In addition, as described above, the determining operation 1004 may also be at least in part based on a direction of the GEO arch relative to the antenna. Further still, the determining operation 1004 may factor any or all of the foregoing parameters discussed above that may affect the offset angle. Specifically, the determining operation 1004 may be at least in part based on other satellite antennas in the area of the satellite antenna to assist in load balancing among similarly located antennas as discussed above in relation to FIG. 8.

Once the offset angle is determined in the determining operation 1004, a positioning operation 1006 may physically position the antenna in the offset angle as determined in the determining operation 1004. The determining operation 1004 and/or the positioning operation 1006 may be performed at the initial install and set up of an antenna at a user terminal. In addition, the determining operation 1004 and/or the positioning operation 1006 may be performed at some time subsequent to install (e.g., upon service of an antenna system, upon determining communication difficulties, etc.).

The operations 1000 may include a steering operation 1008 electronically steering a beam of the satellite antenna to communicate with a non-GEO satellite. The steering operation 1008 may include tracking a non-GEO satellite as the non-GEO satellite transits in the sky relative to the satellite antenna. The steering operation 1008 may also include cycling to another non-GEO satellite upon loss of signal (LOS) with a current non-GEO satellite with which the antenna is in communication or upon acquisition of signal (AOS) with a newly visible non-GEO satellite transiting into an extent of visibility of the satellite antenna. Moreover, the steering operation 1008 may include interference avoidance to avoid interference with a non-target satellite (e.g., another non-GEO satellite or a GEO satellite).

The operations 1000 may also include a steering operation 1010 in which the beam of the satellite antenna is steered to communicate with a GEO satellite in the GEO arch visible by the satellite antenna. The steering operations 1008 and 1010 may each be performed without physical movement of the satellite antenna from the set physical position in which the satellite antenna was positioned in the positioning operation 1006. That is, as the offset angle may help to facilitate communication with both non-GEO and GEO satellites, the steering operations 1008 and 1010 may each be accomplished to establish communication with a non-GEO satellite and GEO satellite, respectively, without physical movement of the satellite antenna.

FIG. 11 illustrates an example schematic of a computing device 1100 suitable for implementing aspects of the disclosed technology including an antenna controller 1150 and/or an offset determination module 1152 corresponding to the examples described above. The computing device 1100 includes one or more processor unit(s) 1102, memory 1104, a display 1106, and other interfaces 1108 (e.g., buttons). The memory 1104 generally includes both volatile memory (e.g., RAM) and non-volatile memory (e.g., flash memory). An operating system 1110, such as the Microsoft Windows® operating system, the Apple macOS operating system, or the Linux operating system, resides in the memory 1104 and is executed by the processor unit(s) 1102, although it should be understood that other operating systems may be employed.

One or more applications 1112 are loaded in the memory 1104 and executed on the operating system 1110 by the processor unit(s) 1102. Applications 1112 may receive input from various input local devices such as a microphone 1134, input accessory 1135 (e.g., keypad, mouse, stylus, touchpad, joystick, instrument mounted input, or the like). Additionally, the applications 1112 may receive input from one or more remote devices such as remotely-located smart devices by communicating with such devices over a wired or wireless network using more communication transceivers 1130 and an antenna 1138 to provide network connectivity (e.g., a mobile phone network, Wi-Fi®, Bluetooth®). The computing device 1100 may also include various other components, such as a positioning system (e.g., a global positioning satellite transceiver), one or more accelerometers, one or more cameras, an audio interface (e.g., the microphone 1134, an audio amplifier and speaker and/or audio jack), and storage devices 1128. Other configurations may also be employed.

The computing device 1100 further includes a power supply 1116, which is powered by one or more batteries or other power sources and which provides power to other components of the computing device 1100. The power supply 1116 may also be connected to an external power source (not shown) that overrides or recharges the built-in batteries or other power sources.

In an example implementation, the computing device 1100 comprises hardware and/or software embodied by instructions stored in the memory 1104 and/or the storage devices 1128 and processed by the processor unit(s) 1102. The memory 1104 may be the memory of a host device or of an accessory that couples to the host. Additionally or alternatively, the computing device 1100 may comprise one or more field programmable gate arrays (FPGAs), application specific integrated circuits (ASIC), or other hardware/software/firmware capable of providing the functionality described herein.

The computing device 1100 may include a variety of tangible processor-readable storage media and intangible processor-readable communication signals. Tangible processor-readable storage can be embodied by any available media that can be accessed by the computing device 1100 and includes both volatile and nonvolatile storage media, removable and non-removable storage media. Tangible processor-readable storage media excludes intangible communications signals and includes volatile and nonvolatile, removable and non-removable storage media implemented in any method or technology for storage of information such as processor-readable instructions, data structures, program modules or other data. Tangible processor-readable storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other tangible medium which can be used to store the desired information and which can be accessed by the computing device 1100. In contrast to tangible processor-readable storage media, intangible processor-readable communication signals may embody processor-readable instructions, data structures, program modules or other data resident in a modulated data signal, such as a carrier wave or other signal transport mechanism. The term “modulated data signal” means an intangible communications signal that has one or more of its characteristics set or changed in such a manner as to encode information in the signal. By way of example, and not limitation, intangible communication signals include signals traveling through wired media such as a wired network or direct-wired connection, and wireless media such as acoustic, RF, infrared, and other wireless media.

Some implementations may comprise an article of manufacture. An article of manufacture may comprise a tangible storage medium to store logic. Examples of a storage medium may include one or more types of processor-readable storage media capable of storing electronic data, including volatile memory or non-volatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, operation segments, methods, procedures, software interfaces, application program interfaces (API), instruction sets, computing code, computer code, code segments, computer code segments, words, values, symbols, or any combination thereof. In one implementation, for example, an article of manufacture may store executable computer program instructions that, when executed by a computer, cause the computer to perform methods and/or operations in accordance with the described implementations. The executable computer program instructions may include any suitable type of code, such as source code, compiled code, interpreted code, executable code, static code, dynamic code, and the like. The executable computer program instructions may be implemented according to a predefined computer language, manner or syntax, for instructing a computer to perform a certain operation segment. The instructions may be implemented using any suitable high-level, low-level, object-oriented, visual, compiled and/or interpreted programming language.

The implementations described herein are implemented as logical steps in one or more computer systems. The logical operations may be implemented (1) as a sequence of processor-implemented steps executing in one or more computer systems and (2) as interconnected machine or circuit modules within one or more computer systems. The implementation is a matter of choice, dependent on the performance requirements of the computer system being utilized. Accordingly, the logical operations making up the implementations described herein are referred to variously as operations, steps, objects, or modules. Furthermore, it should be understood that logical operations may be performed in any order, unless explicitly claimed otherwise or a specific order is inherently necessitated by the claim language.

While the invention has been illustrated and described in detail in the drawings and foregoing description, such illustration and description is to be considered as exemplary and not restrictive in character. For example, certain embodiments described hereinabove may be combinable with other described embodiments and/or arranged in other ways (e.g., process elements may be performed in other sequences). Accordingly, it should be understood that only the preferred embodiment and variants thereof have been shown and described and that all changes and modifications that come within the spirit of the invention are desired to be protected.

For the purposes of this disclosure, unless otherwise indicated, all numbers expressing amounts, sizes, dimensions, proportions, shapes, formulations, parameters, percentages, quantities, characteristics, and other numerical values used in the specification and claims, are to be understood as being modified in all instances by the term “about” even though the term “about” may not expressly appear with the value, amount or range. Accordingly, unless indicated to the contrary, the numerical parameters set forth herein are not and need not be exact, but may be approximate and/or larger or smaller as desired, reflecting tolerances, conversion factors, rounding off, measurement error and the like, and other factors known to those of skill in the art depending on the desired properties sought to be obtained by the presently disclosed subject matter. For example, the term “about,” when referring to a value can be meant to encompass variations of, in some examples ±100%, in some examples ±50%, in some examples ±20%, in some examples ±10%, in some examples ±5%, in some examples ±1%, in some examples ±0.5%, and in some examples ±0.1% from the specified amount, as such variations are appropriate to perform the disclosed methods.

Further, the term “about” when used in connection with one or more numbers or numerical ranges, should be understood to refer to all such numbers, including all numbers in a range and modifies that range by extending the boundaries above and below the numerical values set forth. The recitation of numerical ranges by endpoints includes all numbers, e.g., whole integers, including fractions thereof, subsumed within that range (for example, the recitation of 1 to 5 includes 1, 2, 3, 4, and 5, as well as fractions thereof, e.g., 1.5, 2.25, 3.75, 4.1, and the like) and any range within that range.

1. A user terminal of a satellite communication system, comprising:
an electronically steerable satellite antenna having a steerable beam for communication with at least one of a plurality of non-geosynchronous earth orbit (non-GEO) communication satellites and at least one geosynchronous earth orbit (GEO) communication satellite, wherein the steerable beam is electronically steerable through a scan angle relative to a boresight direction of the electronically steerable satellite antenna;
an offset calculation module to determine an offset angle relative to a zenith direction at the user terminal for the electronically steerable satellite antenna based on a location of the user terminal on Earth and an angle of inclination of the plurality of non-GEO communication satellites of the satellite communication system;
a physical antenna mount for securing the electronically steerable satellite antenna in a static physical orientation relative to Earth that does not change under normal operational conditions of the electronically steerable satellite antenna, wherein the static physical orientation of the electronically steerable satellite antenna secured by the physical antenna mount positions the boresight direction of the electronically steerable satellite antenna at the offset angle; and
wherein the offset angle is in an equatorial direction toward the at least one GEO communication satellite, and wherein the offset angle provides a tilted extent of visibility of the scan angle that includes-at least one of the plurality of non-GEO communication satellites and the at least one GEO communication satellite.

2. The user terminal of claim 1, wherein the offset angle comprises a longitudinal offset component, and wherein the longitudinal offset component is at least in part based on the angle of inclination of the plurality of non-GEO communication satellites.

3. The user terminal of claim 2, wherein the longitudinal offset component is determined to maximize the plurality of non-GEO communication satellites within the tilted extent of visibility.

4. The user terminal of claim 2, wherein the longitudinal offset component is determined as a function of a latitude of the location of the user terminal on Earth.

5. The user terminal of claim 2, wherein the offset angle comprises a latitudinal offset component, and wherein the latitudinal offset component is determined based on a load balancing policy relative to one or more other user terminal configured for communication with the plurality of non-GEO communication satellites.

6. The user terminal of claim 1, wherein the plurality of non-GEO communication satellites pool in a pooling region in a direction toward the GEO communication satellite relative to the user terminal.

7. The user terminal of claim 1, wherein the offset angle is at least in part based on a first link performance of the plurality of non-GEO communication satellites and a second link performance of the at least one GEO communication satellite.

8. The user terminal of claim 1, wherein the offset angle is at least in part based on a first data amount to be communicated between the user terminal and the plurality of non-GEO communication satellites and a second data amount to be communicated between the user terminal and the at least one GEO communication satellite.

9. The user terminal of claim 1, wherein the scan angle is not greater than about 45 degrees.

10. The user terminal of claim 9, wherein a minimum elevation angle of the steerable beam is not less than about 25 degrees.

11. The user terminal of claim 1, wherein the scan angle is asymmetric about the boresight direction.

12. The user terminal of claim 1, wherein the plurality of non-GEO communication satellites comprise low Earth orbit (LEO) satellites.

13. A method for positioning an electronically steerable satellite antenna at a user terminal, comprising:
determining a location of an electronically steerable satellite antenna on Earth;
determining an offset angle for the electronically steerable satellite antenna at least in part based on the location of the user terminal on Earth and an angle of inclination of a plurality of non-geosynchronous Earth orbit (non-GEO) communication satellites of a satellite communication system with which the electronically steerable satellite antenna is configured for communication, wherein the offset angle is in an equatorial direction toward at least one geosynchronous earth orbit (GEO) communication satellite;
offsetting a boresight direction of the electronically steerable satellite antenna at the offset angle relative to a zenith direction at the user terminal and physically securing the electronically steerable satellite antenna with a physical antenna mount in a static physical orientation relative to Earth at the offset angle that does not change under normal operational conditions of the electronically steerable satellite antenna; and
electronically steering a steerable beam of the electronically steerable satellite antenna through a scan angle relative to the boresight direction to establish a tilted extend of visibility that includes at least one of the non-GEO plurality of communication satellites and the at least one GEO communication satellite.

14. The method of claim 13, wherein the offset angle comprises a longitudinal offset component, and the method further comprises:
determining the longitudinal offset component at least in part based on the angle of inclination of the plurality of non-GEO communication satellites.

15. The method of claim 14, wherein the longitudinal offset component is determined to maximize the plurality of non-GEO communication satellites within the tilted extent of visibility.

16. The method of claim 14, wherein the longitudinal offset component is determined as a function of a latitude of the location of the user terminal on Earth.

17. The method of claim 14, wherein the offset angle comprises a latitudinal offset component, and the method further comprises:
determining the latitudinal offset component based on a load balancing policy relative to one or more other user terminal configured for communication with the plurality of non-GEO communication satellites.

18. The method of claim 13, wherein the plurality of non-GEO communication satellites pool in a direction toward the GEO communication satellite relative to the user terminal.

19. The method of claim 13, wherein the offset angle is at least in part based on a first link performance of the plurality of non-GEO communication satellites and a second link performance of the at least one GEO communication satellite.

20. The method of claim 13, wherein the offset angle is at least in part based on a first data amount to be communicated between the user terminal and the plurality of non-GEO communication satellites and a second data amount to be communicated between the user terminal and the at least one GEO communication satellite.

21. The method of claim 13, wherein the scan angle is not greater than about 45 degrees.

22. The method of claim 21, wherein a minimum elevation angle of the steerable beam is not less than about 25 degrees.

23. The method of claim 13, wherein the scan angle is asymmetric about the boresight direction.

24. The method of claim 13, wherein the plurality of non-GEO communication satellites comprise low Earth orbit (LEO) satellites.
